(19) United States
(12) Patent Application Publication
(10) Pub. No.: US 2006/0095200 A1
(43) Pub. Date: May 4, 2006

(54) Operating device

(75) Inventors: Masaki Ebi, Kariya-city (JP); Makoto Fukumi, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/252,257

(22) Filed: Oct. 18, 2005

(30) Foreign Application Priority Data
Oct. 28, 2004 (JP) 2004-314467

(51) Int. Cl. G01C 21/26; G01C 21/32; G01C 21/36; G01C 21/34

(52) U.S. Cl. 701/200

(57) ABSTRACT

An operating device has multiple operating switches that are displayed in a display device. Each time each operating switch is operated, an operation frequency that is stored is incremented. A control circuit mixes, on the display device, display colors of a background and display colors of the operating switches. When a first operating switch has a high operation frequency, a mixing ratio of the display colors of the background for displaying the first operating switch is lowered. When a second operating switch has a low operation frequency, the mixing ratio of the display colors of the background for the second operating switch is increased. Thus, the operating switches are displayed with transmittancies corresponding to their operation frequencies regardless of whether the background is fixed or variable.

### CROSS REFERENCE TO RELATED APPLICATIONS

This application is based on and incorporates herein by reference Japanese Patent Application No. 2004-314467 filed on Oct. 28, 2004.

1. Field

The present invention relates to an operating device favorably applicable to, for example, an in-vehicle navigation system.

2. Background

Patent Document 1 describes one of conventional operating devices. The operating device described in Patent Document 1 is designed for use in a vehicle compartment, and is so constructed that an operator can easily recognize switches that are frequently used in the operating device.

More specific description will be given. With respect to each of multiple operating switches, the number of times (or frequency) a driver operates the switch is stored. The multiple operating switches are displayed with their color tones (tones) or hues (tints) varied based on the stored numbers of times of operation (or stored operation frequencies). Thus, switches of high operation frequencies and switches of low operation frequencies are distinguishable from each other, and the driver can recognize oft-used switches in a short time.

Patent Document 1 states that the operating device may be embodied as a touch switch panel so designed that operating switches are displayed on a screen, and the switches are operated by directly touching the operating switch screen. Patent Document 1 also states that not only the color tones or hues of the operating switches but also sizes or shapes of the displayed switches can be varied according to their operation frequencies.

Patent Document 1: Japanese Unexamined Patent Publication No. 2002-362188

However, a problem arises when the color tones or hues of operating switches displayed on a screen vary: namely, the conspicuousness of the operating switches may vary depending on a relationship between the display colors of the background and those of the operating switches. More specific description will be given. The color tone or hue of an operating switch can be varied in an attempt to make it conspicuous. However, when the color of the operating switch is similar with that of the background, the operating switch contrarily becomes difficult to identify. For this reason, the operating switches described in Patent Document 1 require some countermeasures such as fixing the background behind the operating switches. This poses a problem that the background is limited for the display of the operating switches.

In the operating device described in Patent Document 1, the display of switches is implemented based on the operation frequency only by the following measures: When the color tone is varied, for example, switches of high operation frequencies are distinctly displayed, and switches of low operation frequencies are dimly displayed. This thereby poses the following problem: it is difficult to determine from a displayed operating switch whether the operating switch is operated at a high frequency, at an average frequency, or the like.

### SUMMARY

The present invention has been made with the foregoing taken into account. A first object of the present invention is to provide an operating device whose operating switches can be displayed in a mode corresponding to an operation frequency without limitation on the background.

A second object of the present invention is to provide an operating device whose operating switches can be displayed in such a manner that it is easily recognized how often each operating switch is operated.

To achieve the above first object, an operating device is provided with the following: A display device is included. A display controlling unit is included for displaying a plurality of operating switches over a background on the display device. An operating unit is included for operating an operating switch of the plurality of operating switches displayed on the display device. A storing unit is further included for storing with respect to each operating switch of the plurality of operating switches an operation frequency at which the each operating switch is operated by the operating unit. Here, the display controlling unit has a function of mixing a display color of the background and a display color of the each operating switch. Furthermore, the mixing ratio of the display color of the background decreases with increase in an operation frequency of the each operating switch stored in the storing unit and the mixing ratio of the display color of the background increases with decrease in the operation frequency of the each operation switch.

The above-mentioned function of mixing the display colors of a background and those of operating switches is known as so-called alpha (α) blending in the field of image processing. According to one aspect of the present invention, this alpha blending technology is applied to operating switches displayed in superimposition on the background.

More specific description will be given. When the mixing ratio of the display colors of a background is lowered in mixing the display colors of the background and those of an operating switch, the transmittancy of the operating switch is lowered. As a result, the operating switch is clearly displayed, and it is easily recognizable. When the mixing ratio of the display colors of the background is increased, the transmittancy of the operating switch is increased. As a result, the background is easy to see through the operating switch, and the operating switch itself is blended into the background and difficult to recognize.

Application of the above-mentioned alpha blending technology to a display of operating switches brings the following advantage: operating switches are displayed with transmittancies corresponding to their operation frequencies regardless of whether the background is fixed or variable. Therefore, each operating switch can be displayed in a mode corresponding to its operation frequency without being restricted by the background.

To achieve the second object, an operating device is provided with the following: A display device is included. A display controlling unit is included for displaying a plurality of operating switches on the display device. An operating unit is included for operating an operating switch of the plurality of operating switches displayed on the display device. A storing unit is further included for storing with respect to each operating switch of the plurality of operating switches an operation frequency at which the each operating switch is operated by the operating unit. Here, the display controlling unit classifies the operation frequencies of the plurality of operating switches into at least three levels based on the operation frequencies of the plurality of operating switches stored in the storing unit. Furthermore, the display controlling unit displays the plurality of operating switches in display modes corresponding to the at least three levels.

As mentioned above, the operation frequency of each operating switch is classified into at least three levels, and each operating switch is displayed in a display mode corresponding to its classification. Thus, the operation frequency of each operating switch can be grasped at a glance at its display.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating the overall configuration of an automobile navigation system to which an operating device according to a first embodiment is applied;

FIG. 2 is an explanatory drawing illustrating image screen data superimposed when a control circuit displays a menu panel on a display device;

FIG. 3 is a flowchart illustrating a process including display of operating switches and the like;

FIG. 4 is an explanatory drawing illustrating an example of a menu panel for which the alpha blending values (transmittances) are varied in correspondence with the operation frequencies;

FIG. 5 is an explanatory drawing illustrating an example of a display in which a map display screen is placed on the background, and the transmittances of operating switches displayed in superimposition thereon are varied:

FIG. 6 is a flowchart illustrating a process executed when a basic menu panel is displayed;

FIG. 7 is a flowchart illustrating a process executed when the environment setting switch is operated in the basic menu panel;

FIG. 8 is a flowchart illustrating the destination setting routine executed when the destination setting switch is operated in the basic menu panel;

FIG. 9 is a flowchart illustrating in detail the process in the destination setting routine illustrated in FIG. 8;

FIG. 10 is an explanatory drawing illustrating an example of the basic menu panel;

FIG. 11 is an explanatory drawing illustrating an example of the environment setting menu panel;

FIG. 12 is an explanatory drawing illustrating an example of an operation frequency setting menu panel;

FIG. 13 is an explanatory drawing illustrating an example of a destination setting menu panel;

FIG. 14 is an explanatory drawing illustrating an example of a facility menu panel displayed when the colors of operating switches are made to differ according to the classification of operation frequencies;

FIG. 15 is an explanatory drawing illustrating an example of a facility menu panel displayed when the sizes of operating switches are made to differ according to the classification of operation frequencies;

FIG. 16 is an explanatory drawing illustrating an example of a facility menu panel displayed when the frame lines of operating switches are made to differ according to the classification of operation frequencies;

FIG. 17 is an explanatory drawing illustrating an example of a facility menu panel displayed when the following measures are taken: operating switches classified under operation frequencies other than the average operation frequency are caused to blink, and the interval of blinking is made to differ according to the classification of operation frequencies;

FIG. 18 is an explanatory drawing illustrating an example of a facility menu panel displayed when the font sizes of characters indicating operating switches are made to differ according to the classification of operation frequencies;

FIG. 19 is an explanatory drawing illustrating an example of a facility menu panel displayed when the font colors of characters indicating operating switches are made to differ according to the classification of operation frequencies;

FIG. 20 is an explanatory drawing illustrating an example of a facility menu panel displayed when the font types of characters indicating operating switches are made to differ according to the classification of operation frequencies; and

FIG. 21 is an explanatory drawing illustrating an example of a facility menu panel displayed when the shapes of operating switches are made to differ according to the classification of operation frequencies.

### DETAILED DESCRIPTION OF THE PREFERRED EMBODIMENTS

### First Embodiment

Hereafter, description will be given to an operating device according to a first embodiment of the present invention. The description of this embodiment takes as an example a case where the operating device is applied in order to operate an automobile navigation system. The equipment and devices to which the present invention is applicable are not limited to the automobile navigation system.

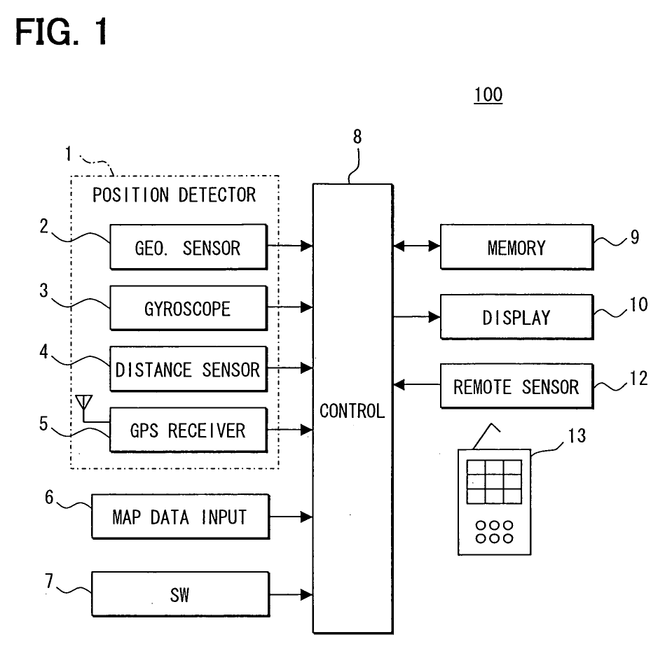

FIG. 1 is a block diagram illustrating the overall configuration of an in-vehicle navigation system 100 to which an operating device according to the first embodiment is applied. As illustrated in the figure, the in-vehicle navigation system 100 in this embodiment comprises a position detector 1, a map data input device 6, an operating switch group 7, an external memory 9, a display device 10, a remote sensor 12, and a control circuit 8 connected with these items.

The control circuit 8 is constructed as an ordinary computer, and is provided therein with publicly known CPU, ROM, RAM, and I/O and bus lines that connect these components. The ROM has programs written therein; the programs are to be executed by the in-vehicle navigation system 100. The CPU and the like perform predetermined arithmetic operations according to these programs.

The position detector 1 includes a geomagnetic sensor 2, a gyroscope 3, a vehicles speed (distance) sensor 4 for computing mileage, and a GPS receiver 5 for GPS (Global Positioning System) that detects the position of a vehicle based on radio waves form satellites. These items are all publicly known. They respectively have errors different in property; therefore, the position detector is so constructed that it uses a plurality of sensors to complement them. The position detector 1 may be constructed of some of the above-mentioned sensors depending on their accuracy.

The map data input device 6 is a device for inputting map data, including data for so-called map matching for the enhancement of position detection accuracy, map drawing data, and data for route search. In general, databases for these data are stored in a playback-only storage medium, such as a CD-ROM and a DVD-ROM, but they may be stored in a writable storage medium, such a memory card and a hard disk.

The operating switch group 7 comprises, for example, a touch panel integrated with the display device 10 or mechanical switches and the like provided around the display device 10. It is used for scrolling a map displayed on the display device 10 and for inputting various items, including inputting an alphabetic character or a numeric character for searching for a desired map or facility or operating a displayed operating switch.

The external memory 9 includes a large-capacity writable and readable storage medium, such as a memory card or an HDD. It is used to store various types of data, including character data, image data, and voice data. As described later, the numbers of times of operation the various switches displayed on the display device 10 are operated are stored as data indicating the operation frequency in the external memory 9.

The display device 10 is, for example, a liquid crystal display. The following can be displayed in the screen of the display device 10 through processing by the control circuit 8: a present position mark corresponding to the present position of the relevant vehicle inputted from the position detector 1; and a map of the area around the relevant vehicle generated from map data inputted from the map data input device 6. Various operating switches are displayed in superimposition on this map display screen. Examples of such operating switches include operating switches for changing the scale of maps and operating switches for changing the display style (two-screen display and one-screen display, and three-dimensional display and two-dimensional display). In addition, the display device 10 displays a menu panel comprising various switches for making various settings for the in-vehicle navigation system 100, or selecting a function to be executed, and the like.

The automobile navigation system in this embodiment has a remote sensor 12 that receives manipulate signals from a remote control terminal (hereafter, referred to as “remote”) 13 by radio. Various operations can also be performed through this remote 13 as by the operating switch group 7. Such operations include inputting conditions for searching for a desired facility, and setting a found facility as the destination. When a destination has been set, the control circuit 8 automatically searches for the optimum route from the present position of the relevant vehicle (or a place of departure specified by the user) to the destination, and computes guided routes. Then, the control circuit executes routing assistance processing according to the guided routes.

The operating device in this embodiment comprises the following items mentioned above: the display device 10 that displays various operating switches; the control circuit 8 that controls the display and, when any of the displayed operating switches is operated, causes the function corresponding to the operating switch to be executed; and the operating switch group 7 and/or the remote 13 for operating any of the various switches displayed on the display device 10.

In a case where the operating switch group 7 has a touch panel, the operating switches displayed on the display device 10 are operated by touching the position where a desired operating switch is displayed. Where the operating switch group 7 includes mechanical switches or the remote 13 is used, a desired one of the various displayed operating switches can be operated by taking the following procedure: move and position the cursor that indicates a selected operating switch on a desired operating switch, and press a switch for giving an instruction to execute the corresponding function, for example, the “ENTER” switch.

The operating device in this embodiment stores, as an operation frequency (or a operation frequency), the number of times the switch is operated in the external memory 9. When an operating switch is operated in the operating switch group 7 or the like, the operating device updates the stored number of times. When various switches are displayed on the display device 10, the display is executed based on the stored numbers of times of operation. Thus, the switches can be displayed in such a manner that operating switches of high operation frequencies are more conspicuous than operating switches of low operation frequencies, without being restricted by the background. Hereafter, the operating device in this embodiment will be described in detail.

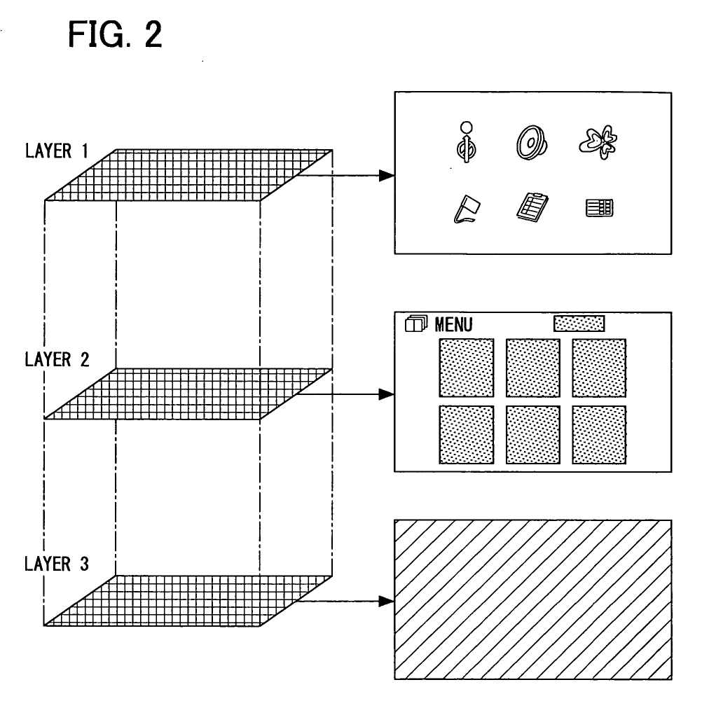

FIG. 2 illustrates pieces of image screen data that are superimposed when the control circuit 8 displays a menu panel on the display device 10. More specific description will be given. The image screen data for displaying the menu panel comprises three layers: Layer 1 positioned at the highest level, Layer 2 positioned at the middle level, and Layer 3 positioned at the lowest level, and the menu panel is drawn in these three layers. An image screen is displayed on the display device 10 as follows: in an area where a higher layer includes an image, that image in the higher layer is displayed, and in an area where a higher layer includes no image, image screen data in a lower layer is displayed. That is, image screen data drawn in a higher layer is preferentially displayed.

For example, the menu panel illustrated in FIG. 2 is drawn as follows: a fixed background is drawn in Layer 3 positioned at the lowest level; shapes that indicate the outlines of operating switches and the like are drawn in Layer 2 positioned at the middle level; and icons and character data corresponding to the operating switches and the like are drawn in Layer 1 positioned at the highest level. Therefore, in the areas where the icons and the character data are displayed and the shapes of the operating switches are displayed, the background image is concealed by them. In case various operating switches are displayed over a map display screen, the pieces of image screen data drawn in Layer 1 and Layer 2 are the same as in the case of the menu panel, but a map is displayed in Layer 3 positioned at the lowest level.

In this embodiment, as mentioned above, three Layers are used, and display screen images are so formed that image screen data drawn in higher layers are preferentially displayed. In this case, an alpha (α) blending value (transmittance) is further set for the icons and switch shapes drawn in the higher layers (Layer 1 and Layer 2). Thus, the user can see the image screen data drawn in Layer 3 positioned at the lowest level through the higher layers regardless of the background. Alpha blending is a technology publicly known in the field of image processing, in which technology, the display colors of the image screens positioned at the higher levels are mixed with those of a background using a coefficient (transmittance), and they are synthesized so that the image screens are translucent. With some coefficients, however, the image screen positioned at a higher level can be varied over a range from completely transparent (colorless) to completely opaque (the background colors are not let through at all).

Therefore, operating switches can be displayed with transmittancies corresponding to their operation frequencies regardless of whether the background is fixed or variable by setting a transmittance corresponding to the operation frequency of each operating switch. When an operation frequency is relatively high, for example, the operating switch can be clearly displayed by setting the transmittance to a low value (including zero). When an operation frequency is relatively low, the operating switch can be blended into the background and made inconspicuous by setting the transmittance to a high value (including 100%). Therefore, each operating switch can be displayed in such a mode that easy recognizability corresponding to its operation frequency is ensured, without being restricted by the background.

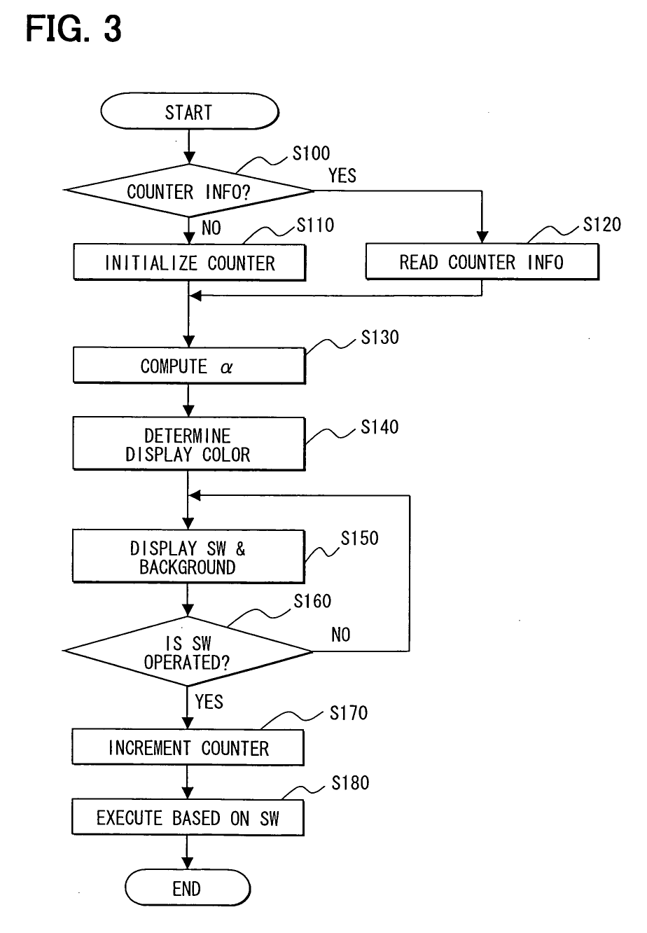

Description will be given to processes, such as display of operating switches, executed by the control circuit 8 with reference to the flowchart in FIG. 3. The flowchart illustrated in FIG. 3 shows the processes executed when an image screen including operating switches is displayed.

At Step S100, it is determined whether information from a counter that counts the numbers of operation of operating switches included in the image screen is stored or not. In the operating device in this embodiment, a counter is set for each of the operating switches displayed on the display device 10. The numbers of times of operation of the operating switches are counted and stored as the individual operation frequencies. At Step S100, it is determined whether the counters brought into correspondence with the operating switches included in the image screen to be displayed have already counted the numbers of times of operation.

When it is determined at Step S100 that there is no counter information, the processing proceeds to Step S110. Here, the counters in correspondence with the individual operating switches are initialized and the count values indicating the numbers of times of operation are set to zero. When it is determined at Step S100 that there is counter information, the processing proceeds to Step S120, and the count values on the individual counters are read.

At Step S130, the alpha blending value (transmittance) of each operating switch is computed based on the count value on each counter initialized at Step S110 or read at Step S120.

Description will be given to an example of methods for alpha blending value computation. The operating switch whose number of times of operation is highest among the operating switches included in a display screen image is selected based on the count values on the counters brought into correspondence with the respective operating switches. The alpha blending value of the operating switch is set to 0% with respect to the operating switch having the highest number of times of operation. Thus, the shape, icon, and the like of the operating switch of the highest number of times of operation become nontransparent, and the operating switch is clearly displayed over the background.

The operating switch whose number of times of operation is lowest among the remaining operating switches is selected, and the alpha blending value of the operating switch is set to a predetermined maximum value (e.g. 90%). Thus, the operating switch of the lowest number of times of operation becomes almost transparent. Therefore, it can be displayed so that it is more inconspicuous than the other operating switches.

With respect to the operating switches having intermediate numbers of times of operation, the alpha blending values corresponding to their respective numbers of times of operation are computed according to the following: the difference from the maximum value and/or the minimum value of number of times of operation, or the ratio to the maximum value and/or the minimum value of number of times of operation.

The above-mentioned computation method is just an example, and the alpha blending value of each operating switch can also be computed by other methods. Some examples will be taken. Relative to the maximum value of number of times of operation among those of operating switches, the alpha blending values of all the remaining operating switches may be computed according to the difference from the maximum value. Or, the numbers of times of operation of operating switches may be averaged, and the alpha blending value of each operating switch may be computed according to the difference from the average value.

At Step S140, the display color of each pixel in each operating switch is determined based on the alpha blending values computed at Step S130. Specifically, the display colors of each operating switch are determined as follows: the display color of each pixel in image screen data of switch shape, icon, and the like, represented by RGB value, is mixed with the display color of the background only to the extent of the ratio expressed as an alpha blending value.

More specific description will be given. When a display screen image comprises three layers, first, a display color of each pixel in the switch shape drawn in Layer 2 can be obtained by taking the following procedure: determine a given ratio of an original display color in Layer 2 as 1 minus the alpha blending value (or the difference when the alpha blending value is subtracted from one), and then mix a display color of the background of a ratio equal to the alpha blending value and the original display color in Layer 2 of the given ratio, to thereby obtain a mixture display color in Layer 2. The display color of each pixel in the icons and the like drawn in Layer 1 can be obtained by taking the following procedure: determine a given ratio of an original display color in Layer 1 as 1 minus the alpha blending value (or the difference when the alpha blending value is subtracted from one), and mix the above-obtained mixture display color in Layer 2 of a ratio equal to the alpha blending value and the original display color in Layer 1 of the above given ratio.

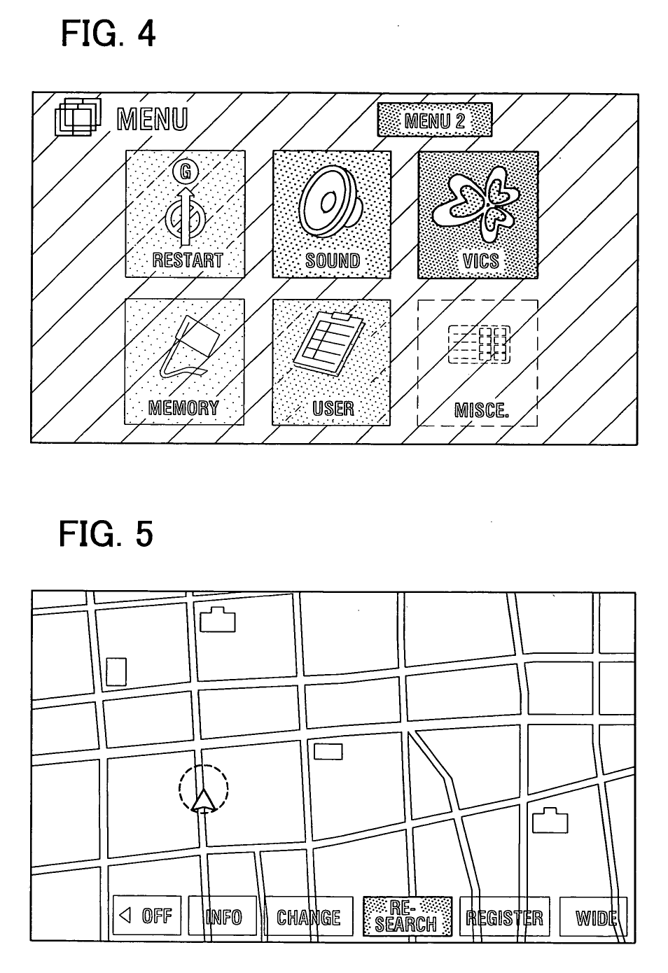

At Step S150, the background and the operating switches are displayed on the display device 10. FIG. 4 illustrates an example of a menu panel for which the alpha blending values (transmittances) are varied in correspondence with the operation frequencies. In the menu panel illustrated in FIG. 4, the transmittance of the VICS switch (VICS) is set to 0% so that the VICS switch is most conspicuous. The transmittances of the other operating switches are set as follows: sound volume setting (SOUND) to 10%, user customizing (USER) to 40%, restart routing assistance (RESTART) to 50%, memory point (MEMORY) to 70%, and miscellaneous settings (MISCE.) to 80%. It is apparent from the figure that the more the transmittance is increased, the more the conspicuousness is lowered.

At Step S160, it is determined whether any operating switch included in the display screen image has been operated or not. When it is determined that an operating switch has been operated, the processing proceeds to Step S170. When it is determined that any operating switch has not been operated, the display of the operating switches and the background is continued.

At Step S170, the count value on the counter for the operated switch is incremented by one. Thus, the numbers of times that the operating switches are actually operated are counted by corresponding counters.

At Step S180, a predetermined function is executed in correspondence with the operated switch. For example, the display screen image is changed, or a selection or setting corresponding to the operating switch is made.

FIG. 5 illustrates an example of a display in which a map display screen is placed on the background, and the transmittances of operating switches displayed in superimposition thereon are varied. As illustrated in FIG. 5, the re-search switch is more clearly displayed than the other operating switches.

Map display screens are not constant in display colors and can be changed with time. Therefore, even if the color tone or hue is made to differ from operating switch to operating switch, there is the possibility that the switches are not made easier to identify as intended because of their relation with the display colors of the background. In this embodiment, meanwhile, easy identifiability is varied according to the transmittancy of each operating switch. Therefore, even if the background is a map display screen, as illustrated in FIG. 5, each operating switch can be displayed in such a mode that easy recognizability corresponding to its operation frequency is ensured.

### Second Embodiment

Description will be given to an operating device according to a second embodiment of the present invention. The configuration of the operating device in the second embodiment is the same as that of the operating device in the first embodiment mentioned above, and the description thereof will be omitted.

The operating device in this embodiment is characterized in that operating switches are displayed so that what an operation frequency each operating switch has is easy to grasp. More specific description will be given. In conventional operating devices, the operation frequency is classified into two levels to vary the color tone or hue. In this case, it is difficult to know, for example, whether a displayed operating switch is an operating switch that is of a high operation frequency and is very frequently used or an operating switch that has an average operation frequency. In this embodiment, consequently, the operation frequency is more finely classified, and each operating switch is displayed in a mode corresponding to its classification.

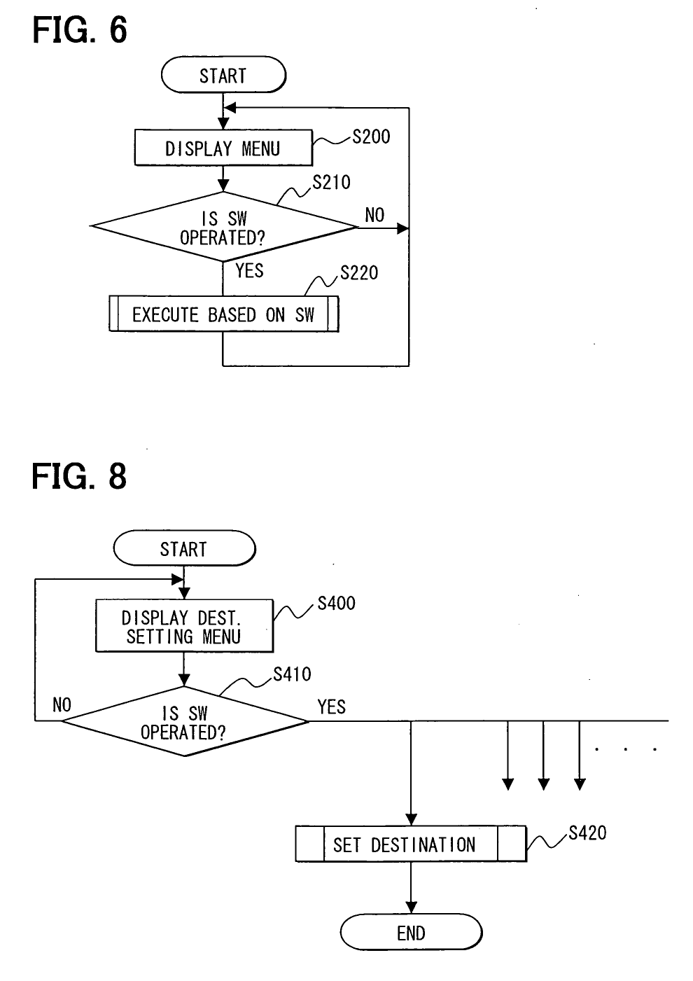

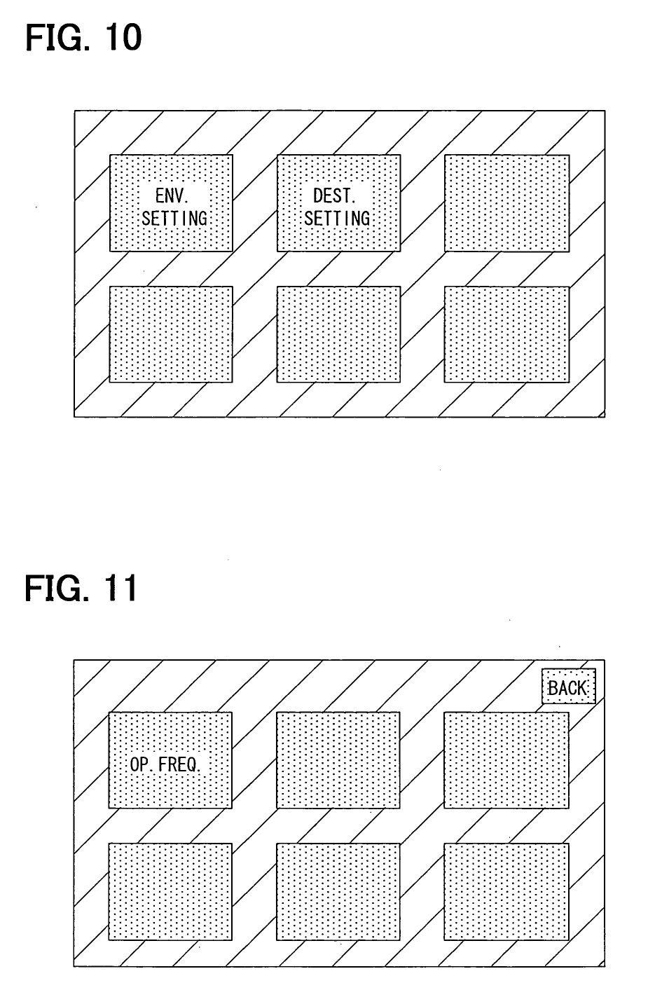

Hereafter, description will be given to the processing to display operating switches in the operating device in this embodiment with reference to the flowcharts in FIG. 6 to FIG. 9 and the examples of display screen images illustrated in FIG. 10 to FIG. 21.

FIG. 6 is a flowchart illustrating a process executed when a basic menu panel is displayed. At Step S200, as illustrated in FIG. 6, the basic menu panel is displayed. FIG. 10 illustrates an example of the basic menu panel. As illustrated in FIG. 10, the basic menu panel shows various operating switches, including environment setting switch (ENV. SETTING) and destination setting switch (DEST. SETTING).

Subsequently, it is determined at Step S210 whether any operating switch in the basic menu panel has been operated or not. When it is determined that switch operation has taken place, the processing proceeds to Step S220, and a process, such as display, selection, or setting, corresponding to the operated operating switch is executed.

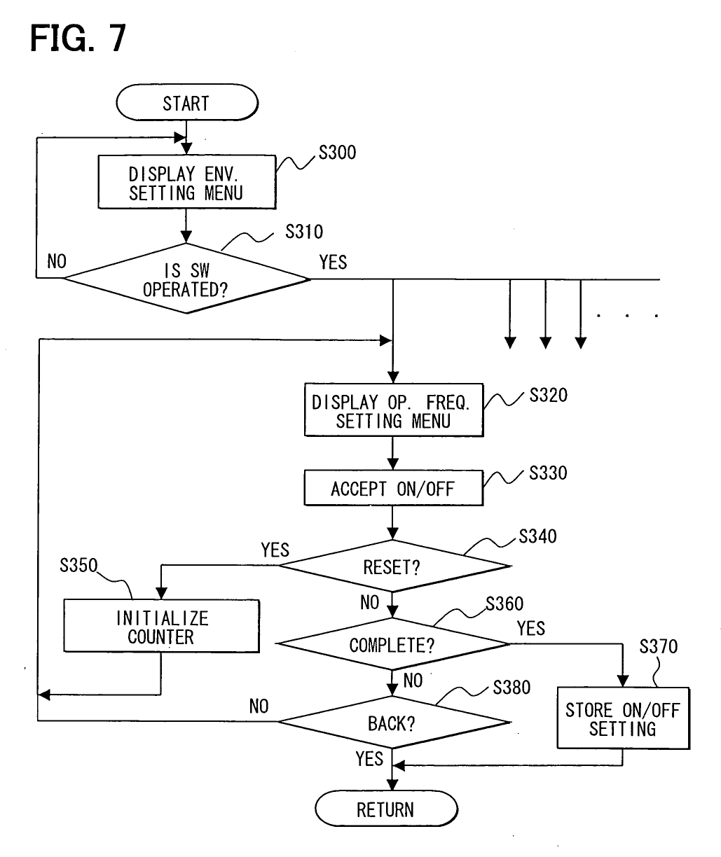

FIG. 7 is a flowchart illustrating a process executed when the environment setting switch is operated in the basic menu panel. FIG. 11 illustrates an example of a display screen image showing an example of the environment setting menu panel. The environment setting menu includes a plurality of operating switches for setting and changing the various operating environments for the in-vehicle navigation system. This environment setting menu also includes an operation frequency switch for setting the operating environment associated with switch display based on the operation frequencies and for performing other like operations.

In the process illustrated in FIG. 7, the processing to display the image screen of an environment setting menu is executed at Step S300. At Step S310, it is determined whether any switch has been operated or not. When it is determined at Step S310 that switch operation has taken place, the routine of processing is executed in correspondence with the operated operating switch. FIG. 7 illustrates the routine of processing executed when the operation frequency switch is operated.

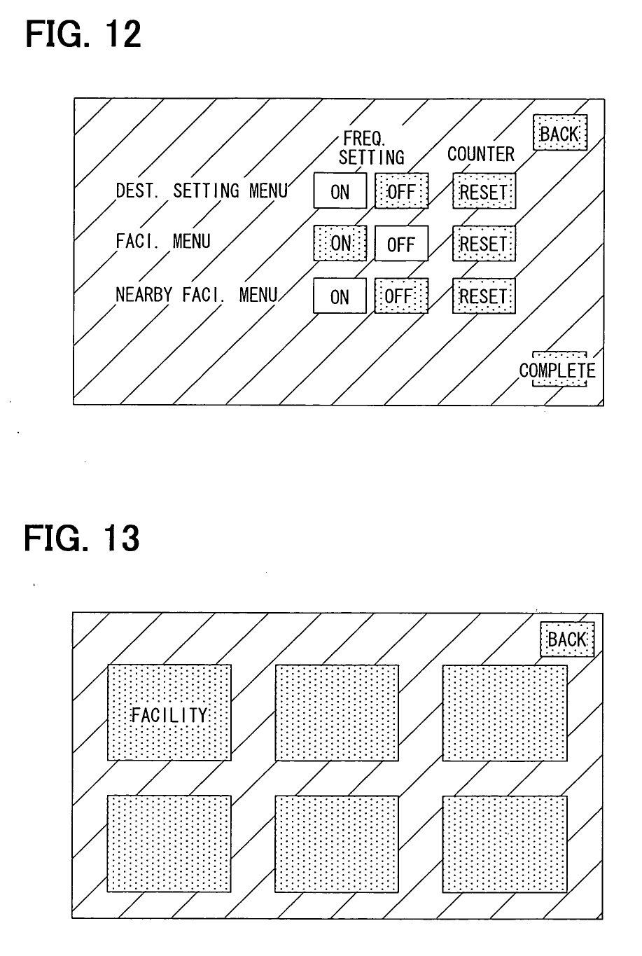

When it is determined that the operation frequency switch has been operated, the processing proceeds to Step S320 in FIG. 7, and the operation frequency setting menu panel is displayed. FIG. 12 illustrates an example of the operation frequency setting menu panel.

As illustrated in FIG. 12, the operation frequency setting menu panel is provided with on and off switches for switching between turn-on and turn-off of the switch display based on the operation frequencies with respect to the following menu panels: destination setting, facility, nearby facility, and the like. The operation frequency setting menu panel is also provided with RESET switches for resetting counters that count the numbers of times of operation of respective operating switches.

At Step S330, input of on/off switches for turning on/off the setting for the operation frequency-based switch display is accepted. Subsequently, it is determined at Step S340 whether any RESET switch has been operated or not. When it is determined a RESET switch has been operated, the processing proceeds to Step S350. At this step, all the counters that count the numbers of times of operation of the operating switches included in the menu corresponding to the operated RESET switch are initialized to zero. Thus, the numbers of times of operation already counted can be cleared when the owner (user) is changed or on other like occasions.

At Step S360, it is determined whether the COMPLETE switch has been operated or not. The COMPLETE switch is operated when input of the on/off settings for the operation frequency-based switch display is completed. Therefore, when it is determined that the COMPLETE switch has been operated, the processing proceeds to S370, and the on/off settings for the operation frequency-based switch display, accepted at Step S330, are stored.

At Step S380, it is determined whether the BACK switch has been operated or not. When it is determined that the BACK switch has not been operated, the processing goes back to Step S320. When it is determined that the BACK switch has been operated, the environment setting process is terminated, and the operation goes back to the processing described in the flowchart in FIG. 6.

With the above-mentioned operation frequency setting menu, the user can set whether to display switches according to their operation frequencies, according to his/her liking on a menu panel-by-menu panel basis. Further, because of the provision of the RESET switch, the user can reset the count value of the number of times of operation of each operating switch anytime desired.

Description will be given to the processing to display switches when the operation frequency-based switch display is set to on. The following description takes as an example a case where the operation frequency-based switch display is executed with respect to the facility menu in the destination setting menu.

When the destination setting switch is operated in the basic menu panel, the destination setting routine illustrated in FIG. 8 is executed. In this destination setting routine, the destination setting menu panel is displayed at Step S400. FIG. 13 illustrates an example of the destination setting menu image screen. In the destination setting menu image screen, a plurality of switches, including facility, nearby facility, address, phone number, memory point, and the like, are displayed so that the destination can be set based on a wide variety of information.

When the facility switch is operated in this destination setting menu panel, the judgment at Step S410 is “Yes,” and the processing proceeds to Step S420. At Step S420, the facility menu panel is displayed, and the user is let to select a facility the user desires to set as the destination from among facilities under a desired category. The selected facility is set as the destination.

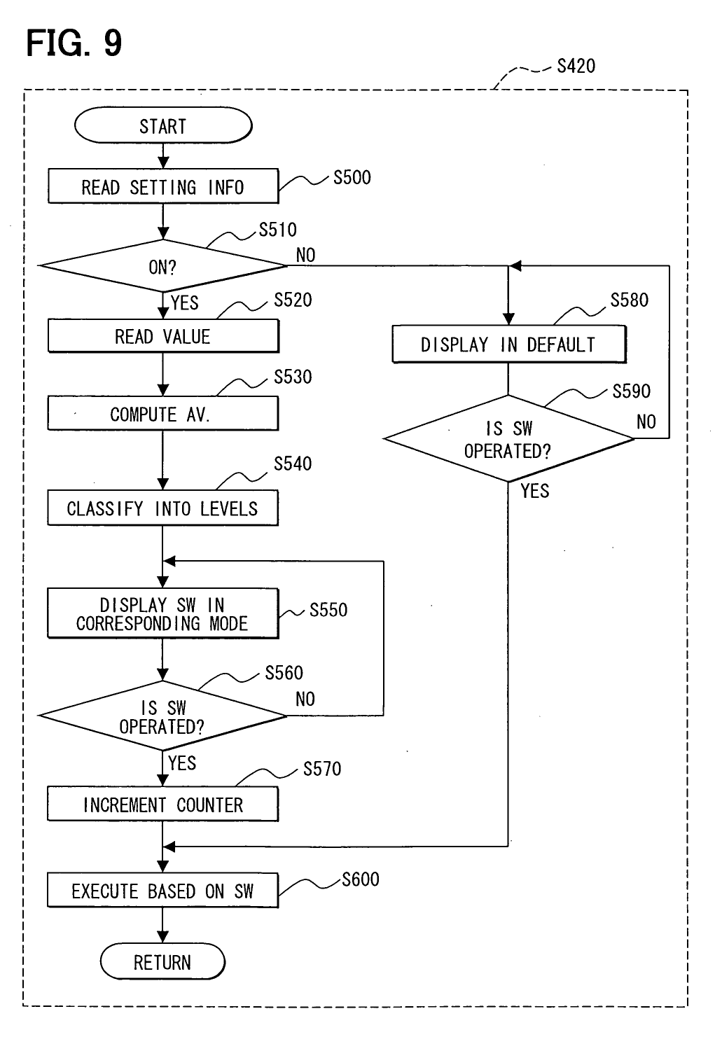

FIG. 9 is a flowchart illustrating the details of the processing of Step S420. At Step S500, the information of setting associated with the operation frequency-based switch display is read. At Step S510, it is determined whether the operation frequency-based switch display is set to on or not. When it is determined that it is set to on, the processing proceeds to Step S520.

At Step S520, the count values on the counters corresponding to the operating switches included in the displayed menu (the facility menu in this case) are read. At Step S530, an averaged value of the read count values is computed. At Step S540, the operation frequency of each operating switch is classified into three levels of a high frequency, an average frequency, or a low frequency relative to the computed averaged value, based on the count value on each counter. For example, when a count value belongs to a predetermined range with the average value at the center, the operation frequency of the relevant operating switch can be classified into the average frequency. When a count value exceeds the predetermined range, the operation frequency of the relevant operating switch is classified into the high frequency. When a count value does not reach the predetermined range, the operation frequency of the relevant operating switch is classified into the low frequency.

The method for classifying the operation frequency is not limited to the foregoing, and any other method of classification may be adopted. For example, the following method may be adopted: the numbers of times of operation of operating switches are arranged in descending order. The number of times of operation of the operating switch that comes midway at this time is used as the basis instead of the above-mentioned average value. In the above-mentioned example, the operation frequency is classified into three levels. Instead, it may be classified into more levels.

At Step S550, each operating switch is displayed over the background in the display mode corresponding to its classification made at Step S540. In this embodiment, consequently, each operating switch is displayed in the default display mode in the initial state in which any operating switch has not been actually operated. When some difference is produced in the number of times of operation, operating switches classified under the average frequency are displayed in the default display mode; operating switches classified under the high frequency are displayed in such a mode that they are more conspicuous than in the default display mode; and operating switches classified under the low frequency are displayed in such a mode that they are more inconspicuous than in the default display mode.

Thus, the user can intuitively recognize operating switches of high operation frequencies and operating switches of low operation frequencies at a glance.

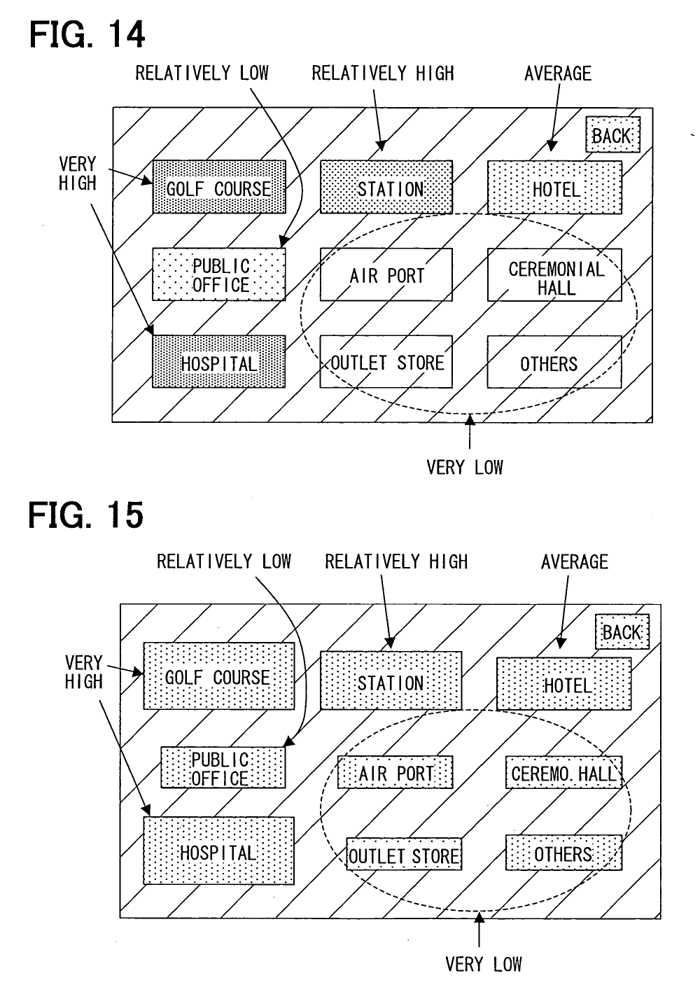

As mentioned above, the operation frequencies of operating switches are classified, and the operating switches are displayed in the display modes corresponding to their classifications. Description will be given to examples of such a method of display with reference to the examples of display screen images illustrated in FIG. 14 to FIG. 21.

In the example illustrated in FIG. 14, the colors of operating switches are made to differ according to their classifications of operation frequencies. In the example in FIG. 14, the operation frequencies are classified into five levels. For example, operating switches (golf course and hospital) of very high operation frequencies are displayed in conspicuous colors, such as yellow and red, when the background is in greenish color or achromatic color, such as gray. Thus, the operating switches of very high operation frequencies can be displayed in such a manner that they are more easily recognizable than the other operating switches.

An operating switch (station) of a relatively high operation frequency is displayed in slightly conspicuous color, such as slightly light yellow. An operating switch (hotel) whose operation frequency is classified into an average frequency is displayed in default color (e.g. dark green or blue). An operating switch (public office) of a relatively low operation frequency is displayed in more inconspicuous color than the default color (e.g. green or blue lighter than the default color). Operating switches (air port, ceremonial hall, outlet store, and others) of very low operation frequencies are displayed in inconspicuous color (e.g. color close to that of the background).

Thus, the display colors are made to differ according to the classified operation frequencies. As a result, a difference can be produced in easy recognizability so that operating switches of higher operation frequencies are more conspicuous and operating switches of lower operation frequencies are more inconspicuous. As the operating switches are repeatedly operated and differences are produced in number of times of operation from operating switch to operating switch, the display colors of each operating switch is changed. For this reason, the user can also intuitively recognize change in operation frequencies at a glance.

In the example illustrated in FIG. 15, the sizes of operating switches are made to differ according to their classifications of operation frequencies. More specific description will be given. As illustrated in FIG. 15, operating switches (golf course and hospital) of very high operation frequencies are displayed in the largest size. As the operation frequency becomes lower, operating switches are reduced in size. Thus, the sizes of the operating switches are made to differ according to the classified operation frequencies. As a result, a difference can be produced in easy recognizability between operating switches so that operating switches of higher operation frequencies are more conspicuous and operating switches of lower operation frequencies are more inconspicuous.

As illustrated in FIG. 15, an operating switch (hotel) classified under the average frequency is displayed in a default size. Therefore, operating switches of high operation frequencies are gradually increased in size from the default size as they are repeatedly operated. Operating switches of low operation frequencies are gradually reduced in size from the default size. Therefore, the user can also intuitively recognize change in operation frequency.

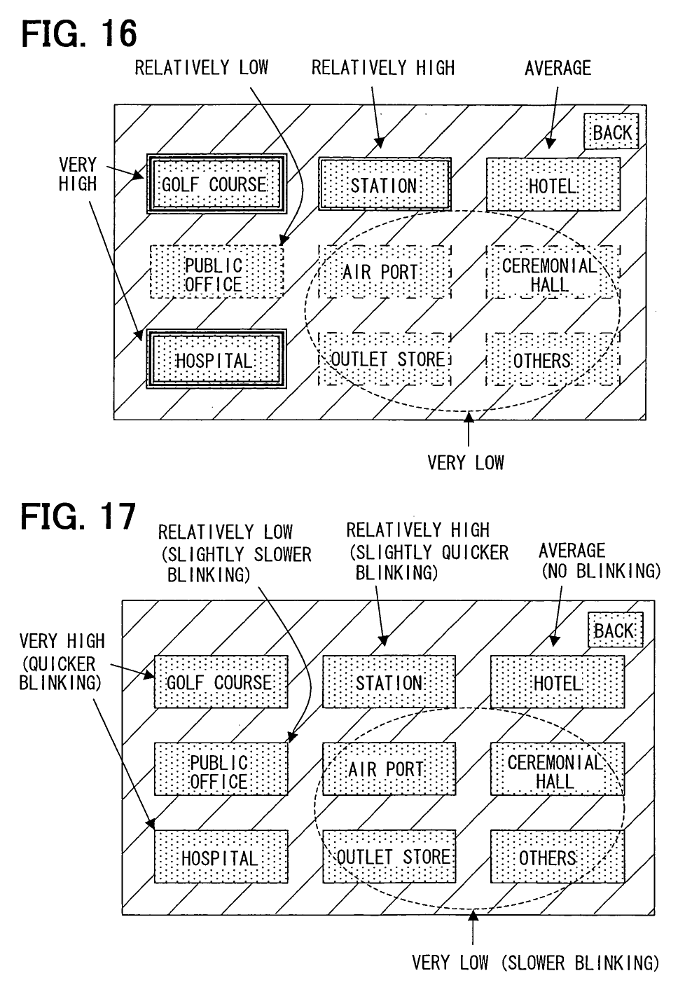

In the example illustrated in FIG. 16, the frame lines of operating switches are made to differ according to their classifications of operation frequencies. More specific description will be given. As illustrated in FIG. 16, operating switches (golf course and hospital) of very high operation frequencies are displayed by a triple frame line. An operating switch (station) of a relatively high operation frequency is displayed by a double frame line, and an operating switch (hotel) of an average operation frequency is displayed by a default frame line (single line). An operating switch (public office) of a relatively low operation frequency is displayed using a closely spaced broken line for its frame line. Operating switches (air port, ceremonial hall, outlet store, and others) of low operation frequencies are displayed using a widely spaced broken line for their frame line.

Thus, the following can also be implemented by changing the types of the frame lines of operating switches according to the classified operation frequencies: the operating switches can be displayed so that operating switches of higher operation frequencies are more conspicuous and operating switches of lower operation frequencies are more inconspicuous.

In the example illustrated in FIG. 17, operating switches classified under operation frequencies other than the average operation frequency are displayed in blinking fashion. Further, the tempo of blinking is made to differ according to the operation switches' classifications of operation frequencies. More specific description will be given. As illustrated in FIG. 17, operating switches (golf course and hospital) of very high operation frequencies are displayed in such a manner that they blink in quick tempo. An operating switch (station) of a relatively high operation frequency is displayed in such a manner than it blinks in tempo slightly quick but slower than that of the operating switches of very high operation frequencies. An operating switch (hotel) of an average operation frequency is not caused to blink when displayed. An operating switch (public office) of a relatively low operation frequency is displayed in such a manner that it blinks in slower tempo than that of blinking of the operating switch of a relatively high operation frequency. Operating switches (air port, ceremonial hall, outlet store, and others) of low operation frequencies are displayed in the slowest tempo.

Thus, the following can also be implemented by changing the tempo of blinking of operating switches according to the classified operation frequencies: the operating switches can be displayed so that operating switches of higher operation frequencies are more conspicuous and operating switches of lower operation frequencies are more inconspicuous.

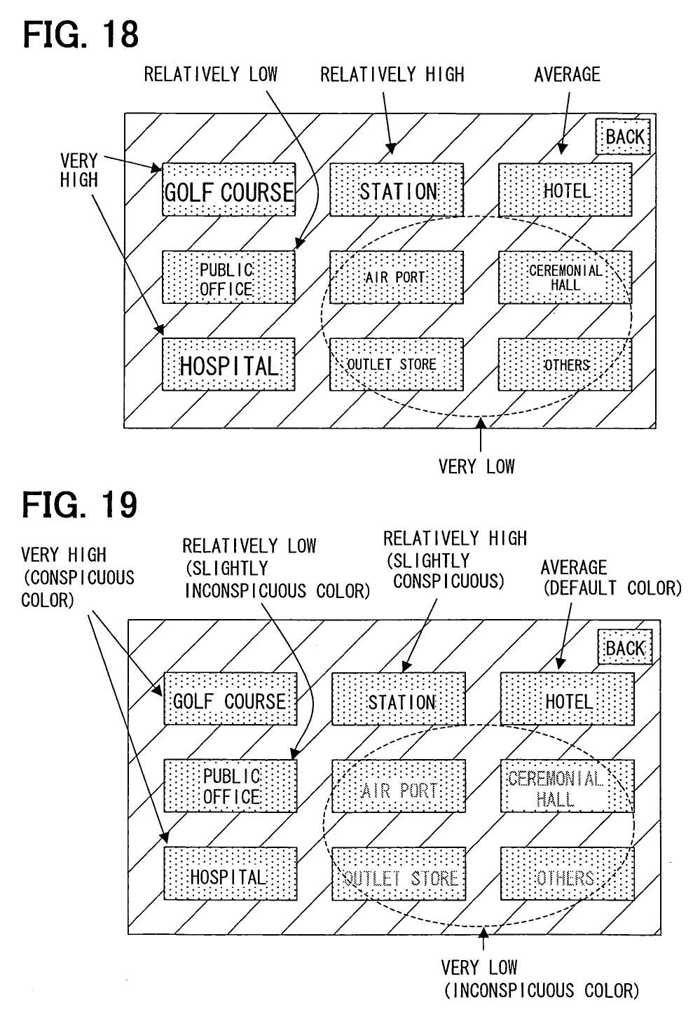

In the example illustrated in FIG. 18, the font sizes of characters indicating operating switches are made to differ according to their classifications of operation frequencies. More specific description will be given. As illustrated in FIG. 18, operating switches (golf course and hospital) of very high operation frequencies are displayed in font in the largest size. As the operation frequency becomes lower, the font size of characters indicating the operating switches is reduced. Thus, the following can also be implemented by varying the font size of characters indicating operating switches according to the classified operation frequencies: the operating switches can be displayed so that operating switches of higher operation frequencies are more conspicuous and operating switches of lower operation frequencies are more inconspicuous.

In the example illustrated in FIG. 19, the font colors of characters indicating operating switches are made to differ according to their classifications of operation frequencies. As illustrated in FIG. 19, for example, the characters for operating switches (golf course and hospital) of very high operation frequencies are displayed in conspicuous font color, such as yellow or red. The characters for an operating switch (station) of a relatively high operation frequency are displayed in slightly conspicuous font color, such as slightly light yellow. The characters for an operating switch (hotel) whose operation frequency is classified into average frequency are displayed in default font color (e.g. black). The characters for an operating switch (public office) of a relatively low operation frequency are displayed in font color more inconspicuous than the default color (e.g. gray lighter than the default color). The characters for operating switches (air port, ceremonial hall, outlet store, and others) of very low operation frequencies are displayed in inconspicuous font color (e.g. color close to that of the background).

Thus, the following can also be implemented by varying the font colors of characters according to the classified operation frequencies: the operating switches can be displayed so that operating switches of higher operation frequencies are more conspicuous and operating switches of lower operation frequencies are more inconspicuous.

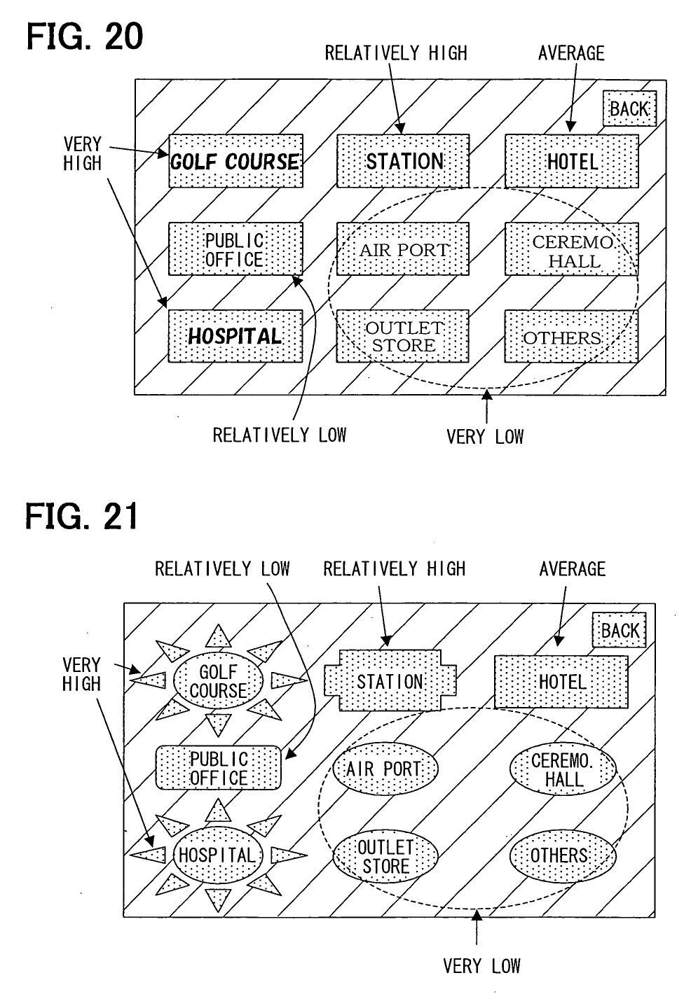

In the example illustrated in FIG. 20, the font types of characters indicating operating switches are made to differ according to their classifications of operation frequencies. More specific description will be given. As illustrated in FIG. 20, the characters for operating switches (golf course and hospital) of very high operation frequencies are displayed using the most conspicuous thick and dark font type. As the operation frequency becomes lower, the thickness and darkness of font types used for displaying the characters for the operating switches are reduced. Thus, the following can also be implemented by varying the font type of characters indicating operating switches according to the classified operation frequencies: the operating switches can be displayed so that operating switches of higher operation frequencies are more conspicuous and operating switches of lower operation frequencies are more inconspicuous.

In the example illustrated in FIG. 21, the shapes of operating switches are made to differ according to their classifications of operation frequencies. More specific description will be given. As illustrated in FIG. 21, operating switches (golf course and hospital) of very high operation frequencies are displayed in outside shape analogous to the sun. An operating switch (station) of a relatively high operation frequency is displayed in cross outside shape, and an operating switch (hotel) of an average operation frequency is displayed in default outside shape (rectangle). An operating switch (public office) of a relatively low operation frequency is displayed in the outside shape of corner-rounded rectangle. Operating switches (air port, ceremonial hall, outlet store, and others) of low operation frequencies are displayed in oval outside shape. Thus, the following can also be implemented by changing the outside shapes of operating switches according to the classified operation frequencies: the operating switches can be displayed so that operating switches of higher operation frequencies are more conspicuous and operating switches of lower operation frequencies are more inconspicuous.

Description will be back to the flowchart in FIG. 9. At Step S550, the operating switches are displayed over the background in display modes corresponding to their classifications of operation frequencies. At Step S560, it is determined whether any switch has been operated or not. When it is determined at Step S560 that switch operation has taken place, the count value on the counter corresponding to the operated operating switch is incremented by one at Step S570. Thereafter, the processing proceeds to Step S600.

When it is determined at Step S510 that the operation frequency-based switch display is set to off, the processing proceeds to Step S580, and each operating switch is displayed over the background in default display mode. At Step S590, it is determined whether any switch is operated or not. When it is determined at Step S590 that switch operation has taken place, the processing proceeds to Step S600.

At Step S600, a predetermined function is executed in correspondence with the operated operating switch. For example, the display screen image is changed, or a selection or setting corresponding to the operating switch is made. When the operating switch for “golf course” is pressed in the facility menu panel, for example, an image screen from which the user can select an area (prefecture or the like) where a desired golf course is located. When operation is performed to select one area from the image screen, the list of the names of golf courses located in the selected area is displayed. When operation is performed to set one of the golf courses in the list as the destination, the routing assistance processing is started with the golf course taken as the destination.

As described above, in the operating device according to the second embodiment, the operation frequency of each operating switch is classified into at least three levels, and each operating switch is displayed in the display mode corresponding to its classification. Therefore, the user can easily grasp the operation frequency of each operating switch at a glance at its display.

When the operation frequency of each operating switch is classified into at least three levels, the categories of a low frequency, an average frequency, and a high frequency are used for classification. Further, operating switches classified under an average frequency are displayed in a default display mode. Thus, the following advantage is brought: as the cumulative number of times of operation of all of the operating switches increases, operating switches of relatively high operation frequencies becomes more conspicuous than in the default display mode. Operating switches of relatively low operation frequencies can be displayed in such a manner that they are more inconspicuous than in the default display mode. Therefore, the user can grasp the operation frequency of each operating switch with accuracy and ease.

It will be obvious to those skilled in the art that various changes may be made in the above-described embodiments of the present invention. However, the scope of the present invention should be determined by the following claims.

What is claimed is:

1. An operating device comprising:
a display device;
a display controlling unit that displays a plurality of operating switches over a background on the display device;
an operating unit that operates an operating switch of the plurality of operating switches displayed on the display device; and
a storing unit that stores with respect to each operating switch of the plurality of operating switches an operation frequency at which the each operating switch is operated by the operating unit,
wherein the display controlling unit has a function of mixing a display color of the background and a display color of the each operating switch, and
wherein the mixing ratio of the display color of the background decreases with increase in an operation frequency of the each operating switch stored in the storing unit and the mixing ratio of the display color of the background increases with decrease in the operation frequency of the each operation switch.

2. The operating device according to claim 1,
wherein the background is an image that varies as a time elapses.

3. The operating device according to claim 1,
wherein the operating device is used to operate a navigation system that displays a map, and
wherein the background is a map display screen in which a display range is able to be moved.

4. The operating device according to claims 1,
wherein the display controlling unit takes a maximum operation frequency from the operation frequencies of the plurality of operating switches as a basis and
wherein the display controlling unit computes the mixing ratio of the display color of the background with respect to the each operating switch according to a difference between the maximum operation frequency and the operation frequency of the each operating switch.

5. An operating device comprising:
a display device;
a display controlling unit that displays a plurality of operating switches on the display device;
an operating unit that operates an operating switch of the plurality of operating switches displayed on the display device; and
a storing unit that stores with respect to each operating switch of the plurality of operating switches an operation frequency at which the each operating switch is operated by the operating unit,
wherein the display controlling unit classifies the operation frequencies of the plurality of operating switches into at least three levels based on the operation frequencies of the plurality of operating switches stored in the storing unit, and
wherein the display controlling unit displays the plurality of operating switches in display modes corresponding to the at least three levels.

6. The operating device according to claim 5,
wherein the display controlling unit changes at least one of:
a color of the each operating switch, a size of the each operating switch, a shape of the each operating switch, a frame line of the each operating switch, a blinking interval of the each operating switch, a color of a font of a character on the each operating switch, a size of a font of a character on the each operating switch, and a type of a font of a character on the each operating switch according to the at least three levels.

7. The operating device according to claim 5,
wherein the display controlling unit classifies the operation frequencies of the plurality of operating switches into the at least three levels of a low frequency, an average frequency, and a high frequency, and
wherein in an initial state, the each operating switch is displayed in a display mode corresponding to the average frequency.

8. The operating device according to claim 7, further comprising:
a resetting unit that clears the operation frequency of the each operating switch stored in the storing unit, and resets the display mode of the each operating switch to the initial state.
